(19) United States
(12) Patent Application Publication
(10) Pub. No.: US 2003/0167463 A1
(43) Pub. Date: Sep. 4, 2003

(54) Custom application-compatibility systems and layers

(75) Inventors: Donald J. Munsil, Kirkland, WA (US); Corneliu I. Lupu, Sammamish, WA (US); Lindsay William Steventon, Redmond, WA (US); Mark Derbecker, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsft Corporation

(21) Appl. No.: 10/090,416

(22) Filed: Mar. 1, 2002

(51) Int. Cl. G06F 9/44

(52) U.S. Cl. 717/170

(57) ABSTRACT

A method, system, and computer-readable medium are provided for creating and dynamically applying a custom application-compatibility fix. A custom database is created for an application that is incompatible with an operating system. The custom database is capable of storing an operating system-provided compatibility fix and an operating system-provided compatibility mode. The operating system-provided compatibility mode is a set of operating system-provided compatibility fixes. A request is received to launch an application. A determination is made as to whether or not there is a custom database for the application to be launched. If there is a custom database for the application to be launched, the operating system-provided compatibility fixes in the custom database are added to a list of compatibility fixes for the application. The listed compatibility fixes are dynamically applied to the requested application and the requested application is launched.

### FIELD OF THE INVENTION

The present invention generally relates to the field of software. More specifically, the present invention relates to providing software application-compatibility fixes.

### BACKGROUND OF THE INVENTION

In the fast-paced computer software field, new software applications and new versions of existing software applications are continually being developed. Many software applications are designed specifically for the operating system in use at the time the software application is developed. For a variety of reasons, many software applications that are designed for a specific operating system do not work correctly with a new release of the operating system. One reason that an application may not work with a new release of the operating system is that application developers do not always follow the programming specifications provided by operating system developers. For example, operating system specifications typically recommend that application developers use an operating system function to determine the location of a file. However, an application developer may believe that a certain type of file is always stored at a specific location in the computer. Instead of following the operating system specifications and requesting the file location from the operating system, the application developer may specify a certain file location in the application program. This may cause the application to be incompatible with a new release of the operating system that stores the file in a different location than that specified in the application program.

Even when application developers do follow the procedures recommended by operating system developers software applications still may not work properly with a new release of an operating system. Oftentimes software developers make assumptions about operating system functions, which may not hold true when a new version of the operating system is released. For example, an application developer may assume that a certain function of the existing operating system always returns a certain value if an error occurs within that function. If previous versions of the operating system returned a value of −1 to indicate an error, an application developer may assume that only a −1 value will be returned in the future to indicate the error. A new version of the operating system may, however, modify the function to return other values based on the error, thereby potentially causing the application program to not work correctly in all situations with a new version of the operating system.

In other instances, an application program may seem to operate correctly with one version of an operating system even though the application program contains errors. Application programs containing errors may operate correctly with an older version of the operating system that does not detect the errors in the application program. Application programs containing errors may also operate correctly with an older version of the operating system that detects the errors in the application program but does not require that the errors be corrected. A new version of the operating system may check for and require correction of the previously undetected or uncorrected errors, thereby causing the application program to be incompatible with the new version of the operating system.

The problems with incompatible applications become more severe as an operating system grows in popularity. When an operating system becomes popular during its release, thousands of applications will be developed specifically for the operating system. The large number of applications, as well as a more diverse group of application developers, may result in many more applications being incompatible with a new version of the operating system. Users of currently working applications may not want to switch to a newer operating system if their applications will not work correctly with the newer operating system.

There are a couple of approaches that have been used in the past to handle compatibility problems between software applications and operating systems. One approach requires application developers to fix their own applications themselves. One disadvantage of this approach is that not all application developers provide fixes or patches for their applications. Even if application developers do provide a patch for their applications, not all users will obtain and correctly install the patches on their computers. This may result in many applications remaining incompatible with a new release of the operating system.

Another approach to handling incompatible application problems involves operating system developers integrating patches for known problem applications into the new version of the operating system. While the operating system patch approach avoids the problem of relying upon application developers to fix their own applications, the operating system patch approach creates many other problems. First, the patches may add a significant amount of code to the operating system, which may significantly increase the space requirements of the operating system. Second, all applications are required to operate through this additional patch layer even though many applications are compatible with the new operating system and do not need the patches to properly operate. The additional patch layer can cause compatible applications programs to unnecessarily run slower. Third, the operating system programming code may become very cluttered due to the number of application programs that may need to be fixed. The cluttered programming code can make it more difficult for the operating system developers to modify and improve the operating system. Finally, it is impossible for an operating system developer to know all of the applications that will not work correctly with a new release of the operating system. Therefore, subsequent patches must be made to the operating system in order to allow these programs to work correctly. This in turn adds another layer to the already complex operating system, which further causes the operating system to operate less efficiently. Therefore, the approach to fixing incompatible applications by providing special code in the operating system can negatively impact other applications as well as the operating system itself.

One operating system distributed by Microsoft Corporation of Redmond, Wash., resolves some of the problems associated with the operating system patch approach described above. The Microsoft operating system enables an application to be patched dynamically and reduces the negative effects on other applications and the operating system. This Microsoft operating system patches an incompatible application by dynamically inserting a dynamic link library into the incompatible application's address space. The dynamic link library determines the functions in the incompatible application that need to be patched and patches those functions. Since this Microsoft operating system is able to dynamically load and apply patches only when needed, other applications and the operating system are not negatively affected. For a more detailed description of dynamic application patching, briefly described above, attention is directed to U.S. patent application Ser. No. 09/513,016, filed Feb. 25, 2000, titled Fixing Incompatible Applications By Providing Stubs For APIs, which is specifically incorporated herein by this reference in its entirety, including any appendices and references therein.

While providing an operating system that is capable of dynamically patching incompatible applications is a significant improvement over prior approaches, it does not solve all of the problems associated with employing the operating system to patch incompatible applications. As described above, operating system developers cannot know all of the applications that will not be compatible with a new release of the operating system. The operating system patch approach does not provide users and software developers with the ability to provide their own patches that can be applied by the operating system. The patches that are provided by an operating system are typically stored in one large read-only database so that the operating system is able to control and protect the patching-related data and prevent corruption of the data by a user or application developer. The operating system patch approach has a significant disadvantage in not allowing users and software developers to customize the application-compatibility data in the read-only database to accommodate the large variety of applications they use and develop. Another disadvantage of the operating system patch approach is that the large read-only database can be updated only by replacing the entire database. If a new application is discovered to be incompatible, the entire database would have to be replaced to integrate the new patch into the operating system. It could be expensive for operating system developers to replace the entire database. It could also be time consuming for the users to install the new database. As a result, the operating system patch approach may not be practical or feasible for handling some application-incompatibility problems.

In summary, prior approaches used to resolve problems associated with incompatible application programs have many disadvantages. While the Microsoft operating system approach described above is a significant advance, it does not solve all of the problems. One disadvantage of the Microsoft operating system approach described above is not enabling users and software developers to customize the operating system-provided patches. With the large number of software applications being developed today and the many different reasons why applications may be incompatible with an operating system, users and software developers have a significant need to customize the application-compatibility data provided by an operating system. At the same time, operating system developers have a significant need to control the operating system and prevent corruption of the operating system's application-compatibility data. In light of the above, a significant need exists for an operating system that allows users and software developers to customize operating system-provided patches and, at the same time, prevents the operating system-provided patches from being corrupted by users and software developers.

### SUMMARY OF THE INVENTION

The present invention solves the above problems by providing a custom application-compatibility system. Generally described, the custom application-compatibility system allows users and software developers to create and dynamically apply custom application-compatibility fixes using custom databases that are capable of storing operating system-provided compatibility fixes and compatibility modes.

According to one aspect of the present invention, a method is provided for dynamically applying a custom application-compatibility fix. A request is received for launching an application. A determination is made as to whether or not there is a custom database for the requested application. The custom database contains an operating system-provided compatibility fix. If there is a custom database for the requested application, the operating system-provided compatibility fix in the custom database is added to a list of compatibility fixes for the requested application. The compatibility fixes on the list are applied to the requested application and the requested application is launched. In another aspect of the present invention, the custom database contains an operating system-provided mode. The operating system-provided compatibility mode contains a set of operating system-provided compatibility fixes. The set of operating system-provided compatibility fixes in the operating system-provided compatibility mode are added to the list of compatibility fixes for the requested application.

According to another aspect of the present invention, a method is provided for creating a custom application-compatibility fix. The application to be fixed is identified. The user selects an operating system-provided compatibility fix. The selected operating system-provided compatibility fix is stored in a custom database for the application to be fixed. In another aspect of the present invention, the user selects an operating system-provided compatibility mode. As described above, the operating system-provided compatibility mode contains a set of operating system-provided compatibility fixes. The set of operating system-provided compatibility fixes in the selected operating system-provided compatibility mode is stored in a custom database for the application to be fixed.

In yet another aspect of the present invention, a computer system is provided for dynamically applying a custom application-compatibility fix. The computer system includes an operating system, an operating system-provided compatibility fix, a plurality of applications, and a custom database for one of the plurality of applications that is incompatible with the operating system. The operating system is operative to receive a request to launch a second one of said plurality of applications and to determine if there is a custom database for said second application. If there is a custom database for said second application, the operating system adds the compatibility fixes in said custom database to a list of compatibility fixes for said second application. The operating system applies said compatibility fixes on said list to said second application and launches said second application. In another aspect of the present invention, the system includes an operating system-provided compatibility mode and the custom database contains an operating system-provided compatibility mode. Again, the operating system-provided compatibility mode contains a set of operating system-provided compatibility fixes. The operating system adds the set of operating system-provided compatibility fixes in the operating system-provided compatibility mode in said custom database to a list of compatibility fixes for said second application.

In yet still another aspect of the present invention, a computer system is provided for creating a custom application-compatibility fix. The computer system includes an operating system, a system database for storing a plurality of operating system-provided compatibility fixes, and another system database for storing a plurality of operating system-provided compatibility modes. The computer system includes a plurality of applications and a custom database for one of said plurality of applications that is incompatible with the operating system. The custom database is capable of storing an operating system-provided compatibility mode and an operating system-provided compatibility fix. The computer system also includes a compatibility administrator application operative to create the custom database for said incompatible application. In a further aspect of the present invention, the compatibility administrator application is further operative to provide a user interface for use in association with creating a custom application-compatibility fix. The user interface is displayed to the user and includes many different features in accordance with different aspects of the invention. For example, one feature provides a user interface that includes an automatic identification option. Upon selection of the automatic identification option, the compatibility administrator application automatically identifies files residing near the application to be fixed. Another feature provides a user interface that includes a test run option. Upon selection of the test run option, the compatibility administrator application applies a user-selected operating system-provided compatibility fix and runs the application in a test mode.

Further aspects of the present invention provide a computer-readable medium for performing the methods of the present invention. Another aspect of the present invention provides a custom database for providing a custom application-compatibility fix that is dynamically applied to an application by the operating system. The custom database is capable of storing any combination of operating system-provided compatibility modes and operating system-provided compatibility fixes.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a block diagram showing an illustrative operating environment for an actual embodiment of the present invention;

FIG. 2 is a block diagram showing an illustrative architecture for the custom application-compatibility system;

FIG. 3 is a block diagram showing an illustrative data structure for the operating system databases and the custom databases;

FIGS. 4A-4C are flow diagrams illustrating the logic used by the custom application-compatibility system for dynamically applying custom application-compatibility fixes;

FIGS. 5A-5E are screen diagrams showing illustrative windows displayed by the compatibility administrator application in creating custom application-compatibility fixes; and

FIGS. 6A-6E are flow diagrams illustrating the logic used by the compatibility administrator application for creating custom application-compatibility fixes.

### DETAILED DESCRIPTION OF THE PREFERRED EMBODIMENT

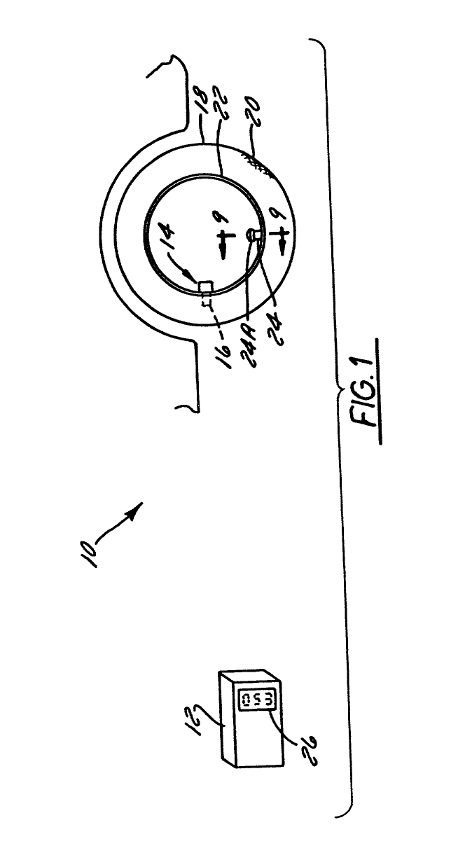

As briefly described above, the present invention provides methods, systems, and computer-readable media for creating and dynamically applying a custom application-compatibility fix. Referring now to the FIGURES, a representative operating environment for an actual embodiment of the present invention is illustrated by FIG. 1. The illustrated computing system environment is only one example of a suitable computing environment and is not intended to suggest any limitation as to the scope of use or functionality of the invention. Neither should the computing environment be interpreted as having any dependency requirement relating to any one or combination of components illustrated in the exemplary operating environment.

The invention is operational in numerous other general purposes or special computing environments or configurations. Examples of well-known computing systems, environments, and/or configurations that may be suitable for implementing the invention include, but are not limited to, personal computers, server computers, laptop devices, multiprocessor systems, microprocessor-based systems, network PCs, minicomputers, mainframe computers, distributed computing environments that include any of the above systems, or the like.

Referring now to FIG. 1, an illustrative computer system for the custom application-compatibility system is described.

The many components of a personal computer system that the client and server may consist of are illustrated in FIG. 1 as computer 110 and may include, but are not limited to, a processing unit 120, a system memory 130, and a system bus 121 that couples various system components, including the system memory, to the processing unit 120. The system bus 121 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus. Computer 110 typically includes a variety of computer-readable media. Computer-readable media can be any available media that can be accessed by computer 110 and include both volatile and nonvolatile media, removable, and nonremovable media. By way of example, and not limitation, computer-readable media may comprise computer storage media and communication media. Computer storage media include both volatile and nonvolatile, removable, and nonremovable media implemented in any method or technology for storage and information, such as computer-readable instructions, data structures, program modules, or other data. Computer storage media include, but are not limited to, RAM, ROM, EEPROM, flash memory or other memory technology, CD-ROM, digital versatile disk (DVD), or other optical disk storage, magnetic cassettes, magnetic tape, magnetic disk storage, or other magnetic storage devices, or any other medium that can be used to store the desired information and which can be assessed by computer 110. Communication media typically embody computer-readable instructions, data structures, program modules, or other data in the modulated data signal, such as a carrier wave or other transport mechanism, and include any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media such as acoustic, RF, infrared, and other wireless media. Combinations of any of the above should also be included within the scope of computer-readable media.

The system memory 130 includes computer storage media in the form of volatile and/or nonvolatile memory such as read-only memory (ROM) 131 and random-access memory (RAM) 132. A basic input/output system 133 (BIOS), contains basic routines that help to transfer information between elements within computer 110, such as program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 140 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as CD-ROM or other optical media. Other removable/nonremovable, volatile/nonvolatile computer storage media that can be used in the exemplary operating environment include, but are not limited to, magnetic tape cassettes, flash memory cards, digital versatile disk, digital videotape, solid state RAM, solid state ROM, and the like. The disk drive 141 is typically connected to the system bus 121 through a nonremovable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information to the computer through input devices such as a keyboard 162 and pointing device 161, commonly referred to as a mouse, trackball, or touchpad. Other input devices (not shown) may include a microphone, joystick, gamepad, satellite dish, scanner, or the like. These and other input devices are often connected to the processing unit 120 through a user-input interface 160 that is coupled to the system bus, but may be connected by other interface and bus structures, such as a parallel port, game port, or universal serial bus (USB). A monitor 191 or other type of display device is also connected to the system bus 121 via an interface, such as a video interface 190. In addition to the monitor, computers may also include other peripheral output devices, such as speakers 197 and printer 196, which may be connected through an output peripheral interface 190.

As discussed earlier, one embodiment of the present invention operates in a networked environment using logical connections to one or more remote computers, such as a remote computer 180. The remote computer 180 may be a personal computer, a server, a router, a network PC, a peer device, or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary, and other means of establishing a communication link between the computers may be used.

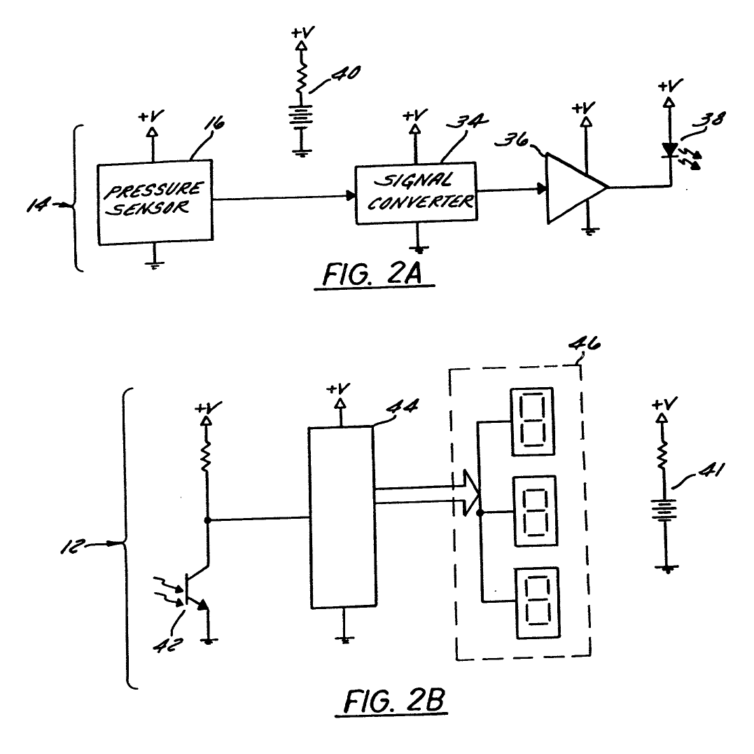

Having described exemplary computing environments in which the present invention may be practiced, attention is directed to FIG. 2, which schematically depicts components of an illustrative embodiment of the custom application-compatibility system 200. In accordance with one embodiment of the present invention, the custom application-compatibility system 200 includes an operating system 134 for controlling execution of application programs 135. The custom application-compatibility system 200 includes a database for storing compatibility fixes 208 that are provided by the operating system 134. The custom application-compatibility system 200 also includes a database storing compatibility modes 210 that are provided by operating system 134. Each operating system-provided compatibility mode 210 contains a set of operating system-provided compatibility fixes 208. The databases for storing the operating system-provided compatibility fixes 208 and the compatibility modes 210 are typically stored using read-only memory to prevent modification and corruption by unauthorized or unknowledgeable parties. The custom application-compatibility system 200 also includes custom databases 212. The custom databases 212 correspond to one or more of the application programs 135 and are capable of storing the operating system-provided compatibility fixes 208 and compatibility modes 210.

In the illustrative embodiment of the present invention, the custom application-compatibility system 200 also includes a compatibility administrator application 206. The compatibility administrator application 206 is a tool designed to assist the user in creating custom application-compatibility fixes for an incompatible application. It will be appreciated by those of ordinary skill in the art that application programs 135 can be incompatible with an operating system 134 on varying levels. For example, an incompatible application may cause the operating system to halt the computer, or the incompatible application may operate as if the application is compatible until a specific event that is unlikely to happen occurs. Therefore, an incompatible application is defined as an application that has been identified as not working properly with an operating system 134. The compatibility administrator application 206 creates custom application-compatibility fixes for application programs 135 by storing selected operating system-provided compatibility fixes 208 and compatibility modes 210 in custom databases 212. The compatibility administrator application 206 will be described in detail below.

FIG. 2 illustrates only one example of a suitable architecture for the custom application-compatibility system and is not intended to suggest any limitation as to the scope of use or functionality of the present invention. Those skilled in the art will appreciate that the present invention may be practiced utilizing various other custom compatibility system architectures, which vary from that illustrated in FIG. 2. For example, in the illustrated embodiment of the present invention shown in FIG. 2, the custom application-compatibility system includes operating system 134 for controlling the execution of application programs 135. One skilled in the art will recognize that the custom compatibility system may utilize a program other than an operating system for controlling execution of an application program. Also, alternative embodiments of the present invention may store the operating system-provided compatibility fixes 208 and the compatibility modes 210 in a single database rather than two separate databases as illustrated in FIG. 2. Additionally, the individual components of the custom application-compatibility system 200 illustrated in FIG. 2 may not necessarily be physically separate components in alternative embodiments of the present invention.

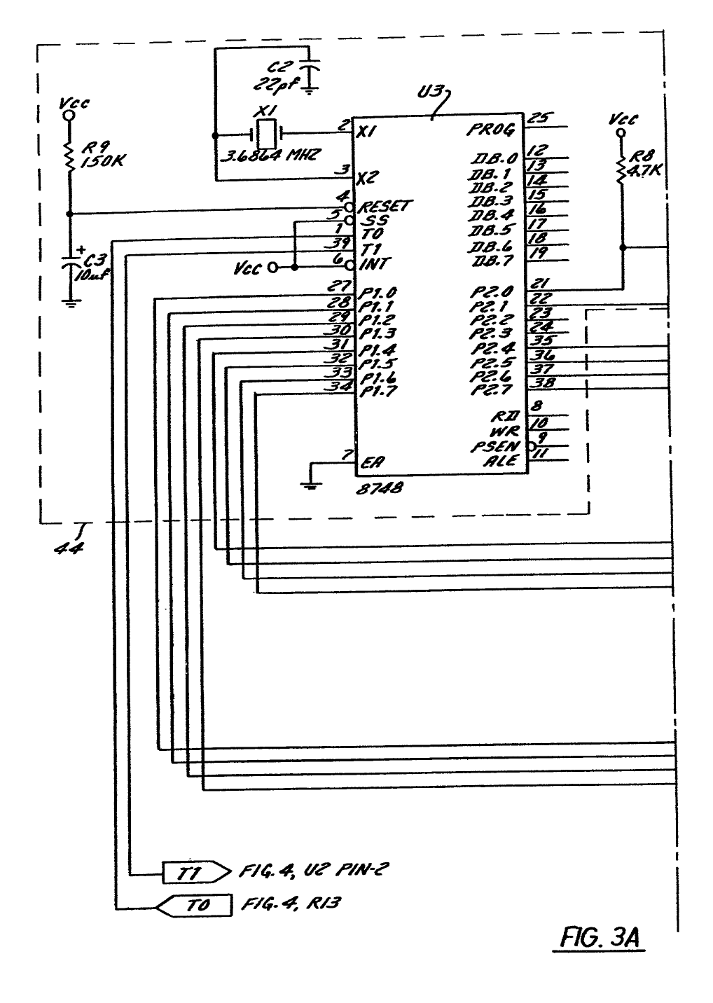

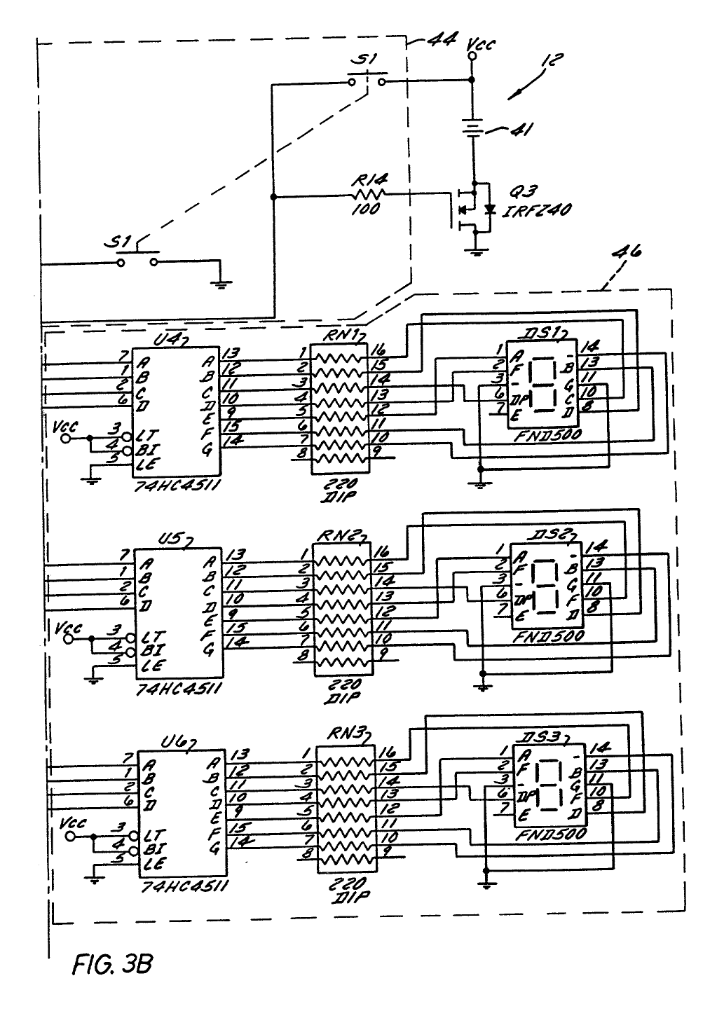

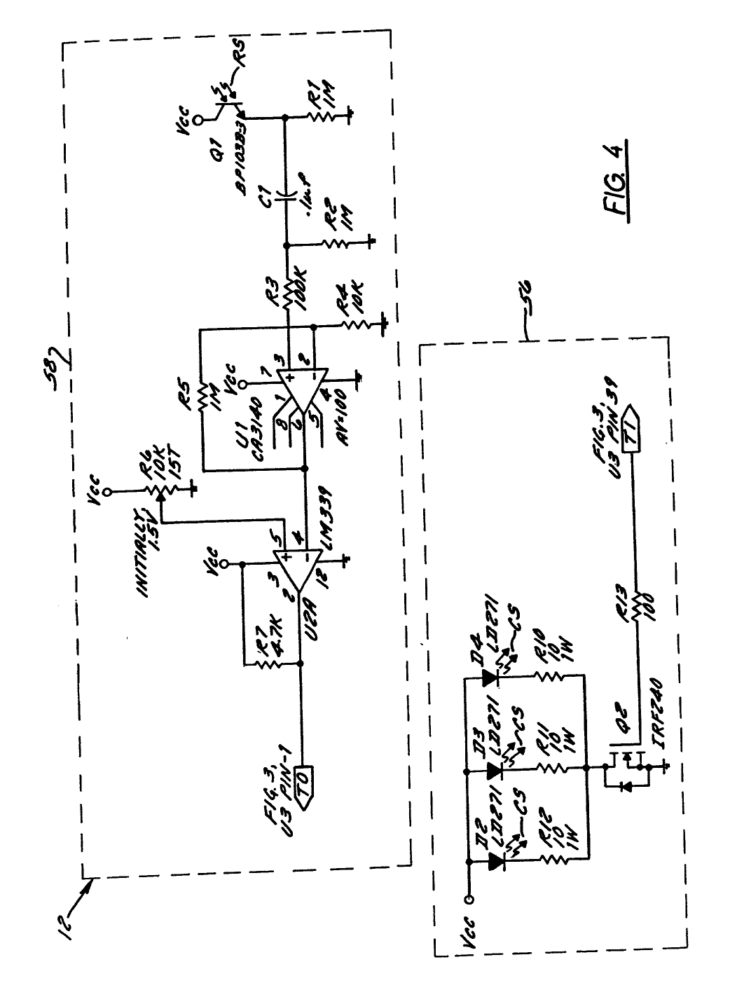

FIG. 3 illustrates databases utilized by the custom application-compatibility system in accordance with one embodiment of the present invention. In the illustrated embodiment, the custom application-compatibility system 200 includes the compatibility fixes database 208, which, as noted above, stores a plurality of operating system-provided compatibility fixes. In one embodiment, the operating system-provided compatibility fixes are stored in a database that includes over 3000 different compatibility fixes. FIG. 3 illustrates the compatibility fixes database 208 as storing compatibility “Fix one” 312 through “Fix n” 322. The compatibility “Fix one” 312 through “Fix n” 322 are provided by the operating system 134. Preferably, the compatibility fix provided by the operating system includes a dynamic link library (DLL). The compatibility fix DLL is also sometimes referred to as a Shim DLL. The Shim DLL compatibility fix can be dynamically inserted into an application program's address space. The Shim DLL compatibility fix determines the functions in the application that need to be patched and patches those functions. It will be appreciated that the DLL is loaded by the operating system for only those applications that have been identified as being incompatible with the operating system. Therefore, applications that are compatible with the operating system are not required to go through an additional operating system level while executing, thereby preserving system resources. For a more detailed description of a method and system for providing Shim DLL compatibility fixes, attention is directed to U.S. patent application Ser. No. 09/513,016, filed Feb. 25, 2000, entitled Fixing Incompatible Applications By Providing Stubs For APIs, which is incorporated herein by reference in its entirety, including any appendices and references therein.

In the illustrative embodiment, the custom application-compatibility system 200 also includes the compatibility modes database 210, which stores a plurality of operating system-provided compatibility modes 342-346. The compatibility modes may also be referred to as “layers.” The compatibility modes 342-346 are sets of compatibility fixes stored in the compatibility fixes database 208. The compatibility modes 342-346 are provided by the operating system 134. Each compatibility mode 342-346 contains a set of compatibility fixes directed to fixing a common compatibility problem between application programs 135 and the operating system 134. The set of compatibility fixes in compatibility modes 342 through 346 can be quickly applied as a group to an incompatible application.

The compatibility modes 342-346 include various combinations of compatibility fixes 312-322 for resolving a variety of incompatibility problems. A compatibility mode may contain a plurality of compatibility fixes or a single compatibility fix. For example, compatibility mode 342 corrects incompatibility Problem A and includes compatibility “Fix two” 314, “Fix three” 316, and “Fix five” 320. Compatibility mode 344 corrects compatibility Problem B and contains compatibility “Fix one” 312 and “Fix four” 318. Compatibility mode 346 corrects compatibility Problem B and contains the single compatibility Fix n 322.

The custom compatibility system 200 also includes the custom databases 212. Each of the custom databases 212 is associated with one or more incompatible applications. The custom databases 212 can be associated with any of the application programs 135 that are identified as being incompatible with the operating system 134. For example, custom database 314 is associated with Application 1 and custom database 362 is associated with Application 2. Each custom database is capable of storing any combination of operating system-provided compatibility fixes 208 and operating system-provided compatibility modes 210. A custom database may store a single compatibility mode. For example, custom database 360 stores the single compatibility mode 342 for problem A. Alternatively, the custom database may store a plurality of compatibility modes. For example, custom database 370 stores compatibility mode 342 for Problem A and compatibility mode 344 for Problem B. Additionally, other custom databases include a plurality of compatibility fixes. For example, custom database 372 stores three compatibility fixes. Still other custom databases include a combination of compatibility modes and compatibility fixes. For example, custom database 364 stores compatibility mode 342 for problem A and compatibility “Fix five” 320.

In the illustrated embodiment, the compatibility fixes database 208, the compatibility modes database 210 and the custom databases 212 are stored on the system memory 130 of computer 110. It will be appreciated by those of ordinary skill in the art that the databases could be stored at many different locations. For example, the databases could be stored on the hard disk drive of the user's personal computer. Alternatively, the databases could be stored at a remote location, such as a Web server or remote host. When stored remotely, the databases can be downloaded though the Internet to the user's computer, or even read directly from a remote host. Still further, the databases could be stored on an optical or magnetic disk, or as mentioned above on a Web server of a remote host.

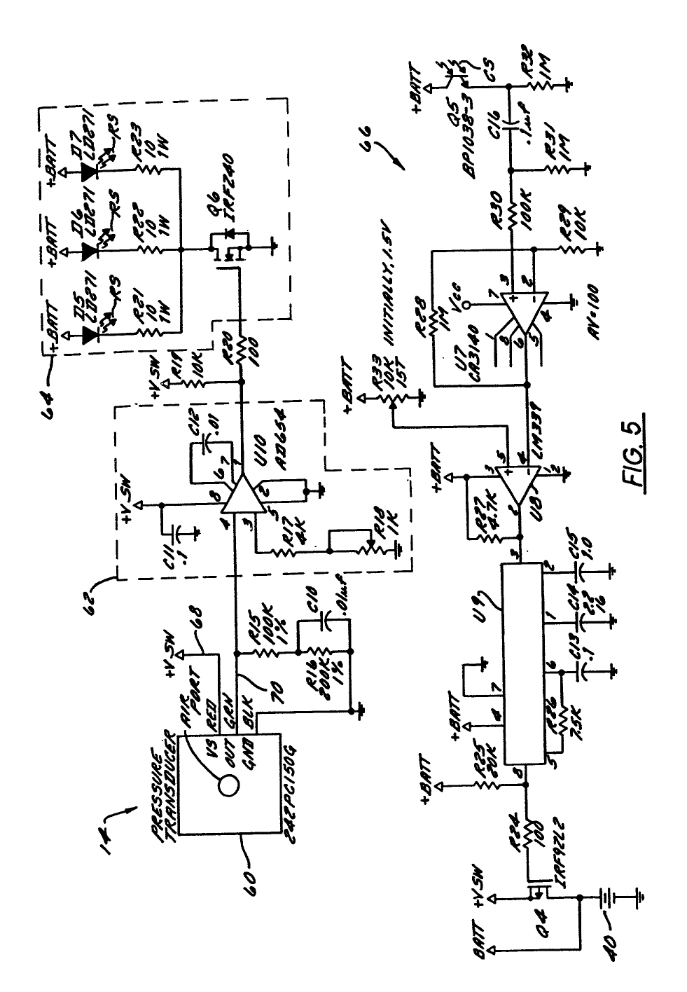

FIG. 4A illustrates a routine 400 for performing a method for dynamically applying a custom application-compatibility fix to an application formed in accordance with this invention. Preferably, the method is practiced as part of the operating system 134. Alternatively, for example, the present invention may also be practiced by a program other than the operating system that controls execution of the application. The routine 400 begins at block 402, where a request to launch an application is received. After receiving a request to launch an application, routine 400 proceeds to decision block 404 where a test is made to determine whether there are any operating system-provided compatibility modes 210 for the application to be launched. As discussed above, operating system-provided compatibility modes 212 contain sets of operating system-provided compatibility fixes 208. If it is determined that there is an operating system-provided compatibility mode for the application, then routine 400 proceeds to block 406. At block 406, routine 400 adds the set of compatibility fixes in the operating system-provided compatibility modes to a list of compatibility fixes for the application to be launched and routine 400 proceeds to decision block 408. If, at decision block 404, it was determined that there are no operating system-provided compatibility modes 210 for the application, routine 400 proceeds to decision block 408.

At decision block 408 shown in FIG. 4A, routine 400 performs a test to determine whether there are any custom databases 212 for the application to be launched. As discussed above, the custom databases 212 are capable of storing operating system-provided compatibility modes 210 and compatibility fixes 208 for an incompatible application. The method for determining whether or not there is a custom database for the application according to one embodiment of the present invention will be described in detail below in the discussion related to FIG. 4C. If there is a custom database for the application to be launched, routine 400 proceeds to block 410. At block 410, routine 400 adds all of the compatibility fixes in the custom databases, including sets of compatibility fixes in compatibility modes, to a list of compatibility fixes for the application to be fixed. In the illustrated embodiment of the present invention, routine 400 proceeds to decision block 412 after adding the compatibility fixes in the custom databases to the list. If, at decision block 408, routine 400 determines that there are no custom databases 212 for the application to be launched, then routine 400 proceeds to decision block 412.

At decision block 412, routine 400 performs a test to determine if there are any operating system-provided compatibility fixes 208 for the application to be launched. If there is an operating system-provided compatibility fix for the application, the routine 400 proceeds to block 414 and the operating system-provided compatibility fixes are added to the list of compatibility fixes for the application. After adding the operating system-provided compatibility fixes to the list for the application, routine 400 proceeds to block 416. Alternatively, if no operating system-provided compatibility fixes for the application are to be added, routine 400 proceeds to block 416.

At block 416 shown in FIG. 4A, routine 400 applies the compatibility fixes on the list to the application to be launched. After applying the compatibility fixes on the list to the application to be launched, routine 400 proceeds to block 418, where the requested application is launched. After launching the requested application with the compatibility fixes applied to the application, routine 400 is completed. Routine 400 illustrates the method of the present invention for dynamically applying custom application-compatibility fixes to an application using custom databases storing operating system-provided compatibility fixes and modes and, at the same time, protects the operating system-provided compatibility fixes and modes from being corrupted by users and software developers.

FIG. 4B illustrates a routine 422 the represents another embodiment of the present invention for dynamically applying a custom application-compatibility fix. The only difference between the embodiment illustrated in FIG. 4B and the embodiment illustrated in FIG. 4A is that, in the FIG. 4B embodiment, the custom databases override the operating system-provided compatibility fixes. This difference is illustrated by line 423, which illustrates that, after adding the compatibility fixes in the custom databases to the list for the application at block 410, routine 422 proceeds to block 416. The existence of a custom database allows routine 422 to bypass block 412 and block 414, which deal with operating system-provided compatibility fixes. The embodiment illustrated in FIG. 4B allows operating system-provided compatibility modes and custom databases to be applied to the application. This embodiment also allows operating system-provided compatibility modes and operating system-provided compatibility fixes to be applied to the application. This embodiment overrides the ability to apply operating system-provided compatibility fixes when there is a custom database for the application. In contrast, the embodiment illustrated in FIG. 4A enables operating system-provided compatibility fixes, operating system-provided compatibility modes, and custom databases to be applied to the application.

In both embodiments of the present invention a particular compatibility fix will be added to the list for the application only once so that the compatibility fix will be applied only once to the application each time the application is launched. It is possible that a certain compatibility fix will be contained in both an operating system compatibility mode and a custom database for an application. This compatibility fix will appear only once on the list for the application, the second entry being ignored.

As discussed earlier in reference to block 408 shown in FIG. 4A, the custom compatibility routine 400 performs a test to determine if there is a custom database for the application, and if so adds the compatibility fixes in the custom database to a list of compatibility fixes for the application. FIG. 4C illustrates a routine 424 formed in accordance with this invention for determining whether there is a custom database for the application to be launched. Preferably, some of the identifying attributes of incompatible applications are stored in a central database and some of the central database is the registry. Alternatively, as will be appreciated by those of ordinary skill in the art, the attributes could be stored at many other locations. For example, the attributes could be stored on the hard disk drive of the user's personal computer. Alternatively, the attributes could be stored at a remote location, such as a Web server or remote host. When stored remotely, the identifying attributes can be downloaded though the Internet to the user's computer, or even read directly from a remote host. Still further, the identifying attributes could be stored on an optical or magnetic disk, or as mentioned above on a Web server of a remote host.

The routine 424 shown in FIG. 4C begins at decision block 426. At decision block 426, a test is made to determine if a central database contains identifying attributes of an incompatible application that matches the application to be launched. In one embodiment of the present invention, one identifying attribute stored in the central database is the name of the application that has been determined to be incompatible with the current operating system. If the name of the application to be launched does not match any of the names contained within the central database, then the application is compatible with the operating system. If the name of the application to be launched does match a name contained within the central database, the application may be incompatible with the operating system and additional identifying attributes are checked to determine if the particular version of the application is incompatible with the operating system. It will be appreciated by those of ordinary skill in the art that an application can be identified many different ways and, as mentioned above, the set of identifying attributes compared could include many different identifying parameters. In some situations, one identifying attribute is sufficient to uniquely identify the incompatible application.

If, at decision block 426, it is determined that the central database does not contain an identifying attribute of an incompatible application that matches the application to be launched, routine 424 proceeds to block 434. If at decision block 426 it is determined that the central database does contain an identifying attribute of an incompatible application that matches the application to be launched, routine 424 proceeds to decision block 428. At decision block 428, a test is performed to determine if the central database contains information about a custom database for the incompatible application. If the central database does not contain information about a custom database for the incompatible application, routine 424 proceeds to block 434. If at decision block 428 it is determined that the central database does contain information about a custom database for the incompatible application, routine 424 proceeds to decision block 430. At decision block 430, a test is made to determine if the custom database for the incompatible application contains additional identifying attributes of the incompatible application that match the application to be launched. If the custom database for the incompatible application does not contain additional identifying attributes of the incompatible application that match the application to be launched, routine 424 proceeds to block 434. If at decision block 430 it is determined that the custom database contains additional identifying attributes that match the application to be launched, routine 424 proceeds to block 432. Block 432 represents that there is a custom database for the application to be launched. Contrariwise, block 434 represents that there is no custom database for the application to be launched. In either case, routine 424 ends after blocks 432 or 434 are reached.

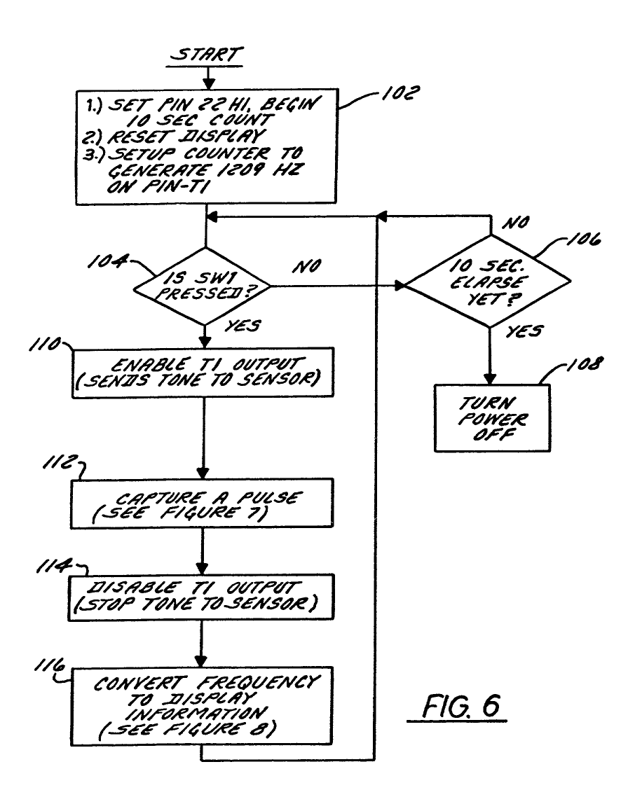

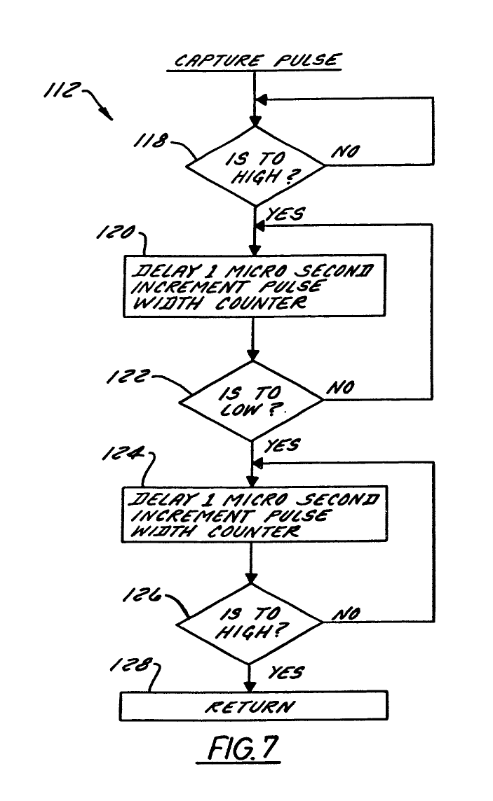

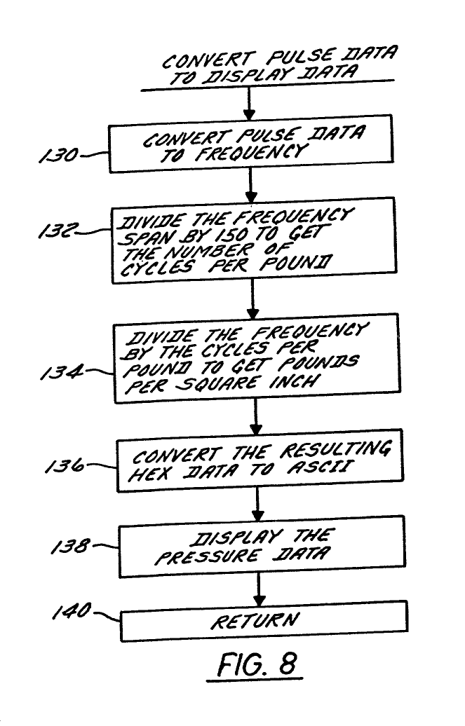

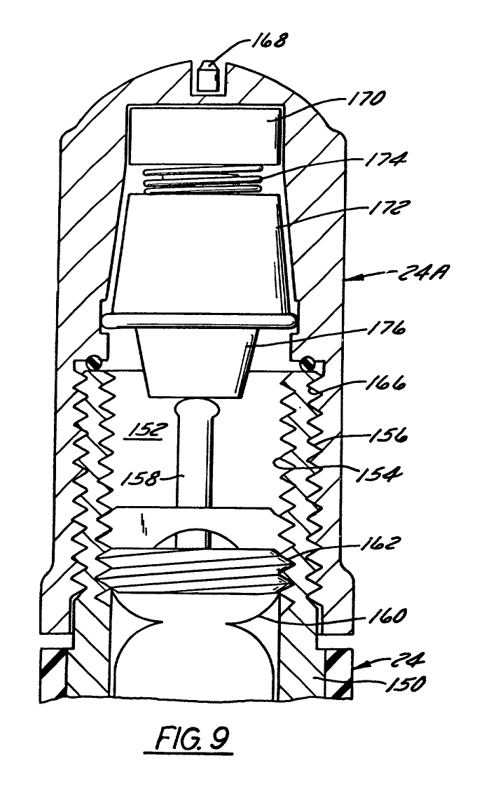

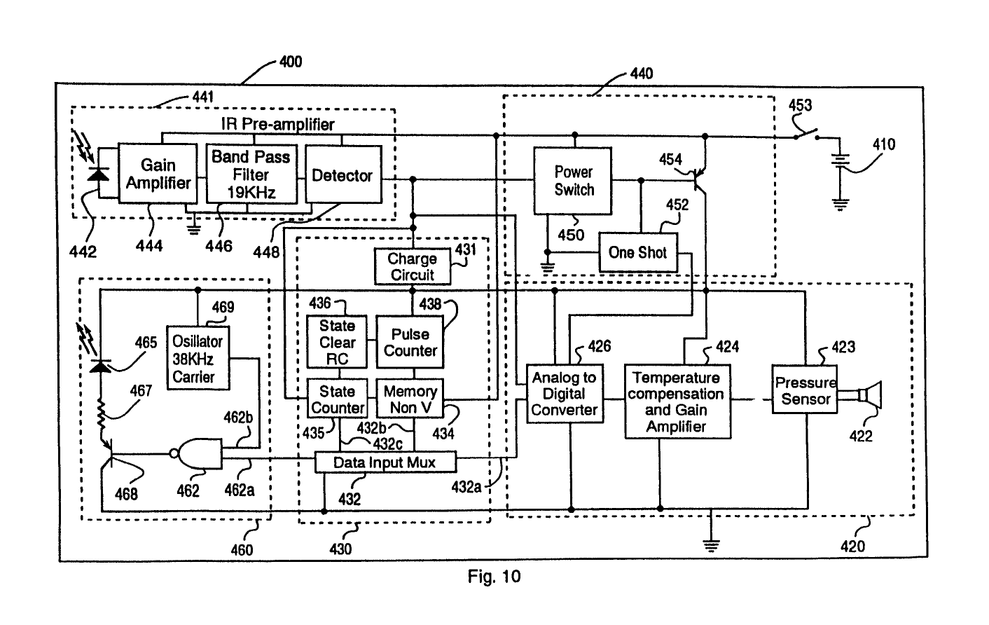

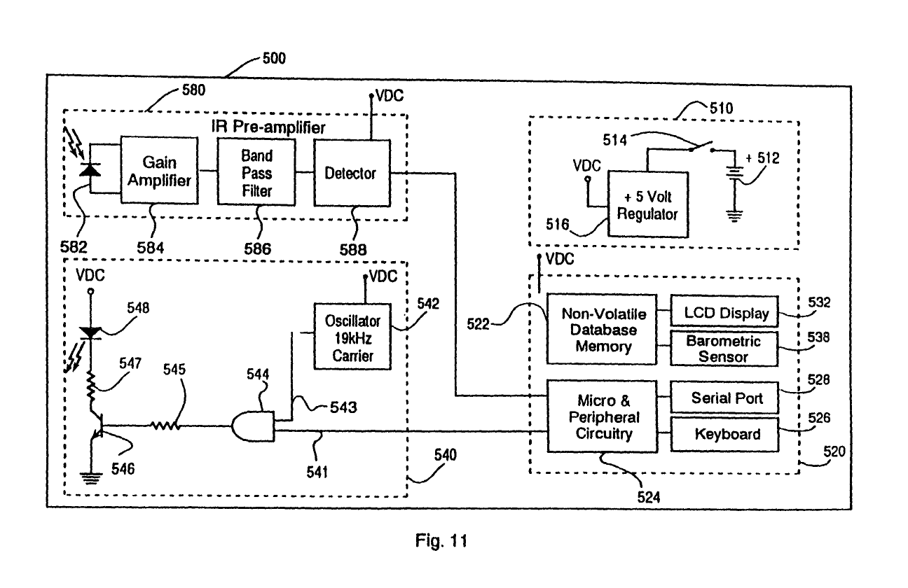

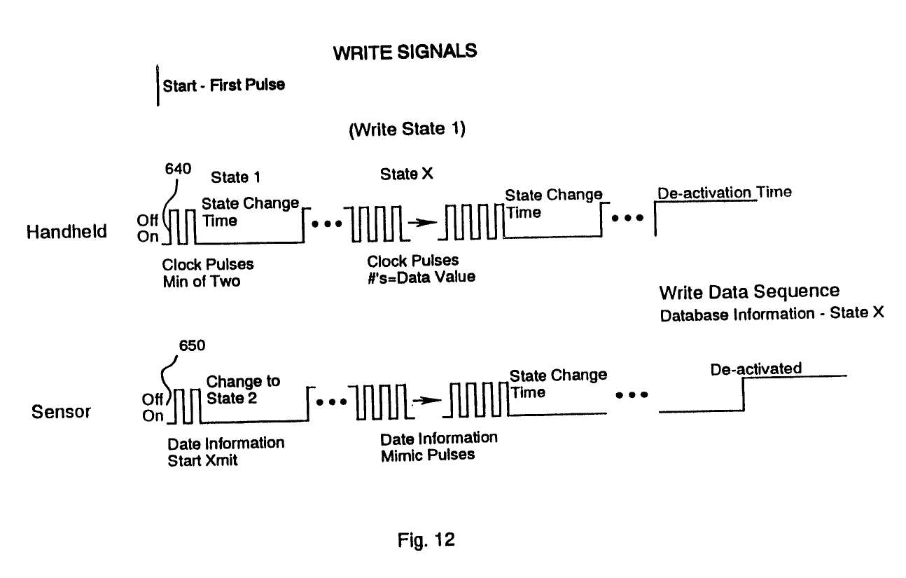

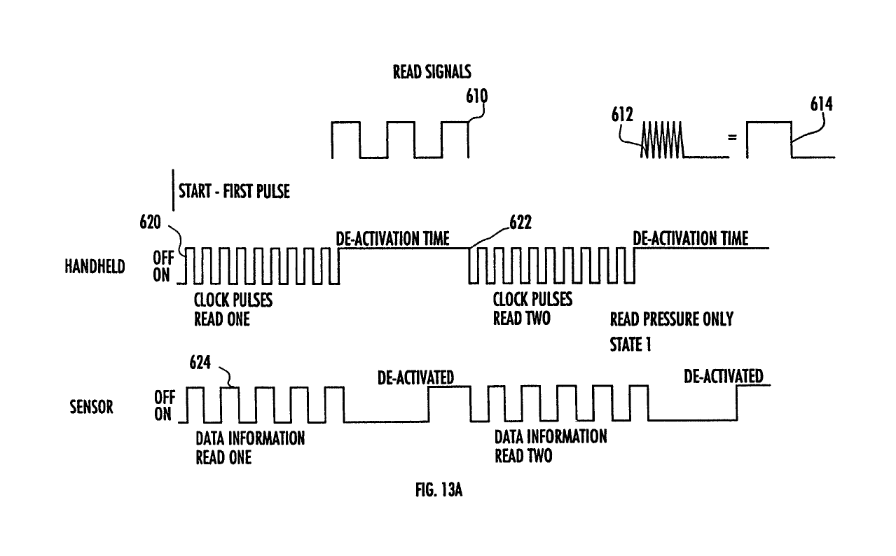

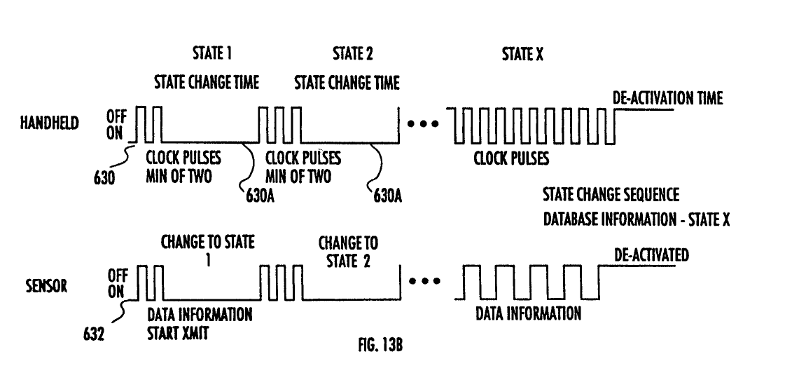

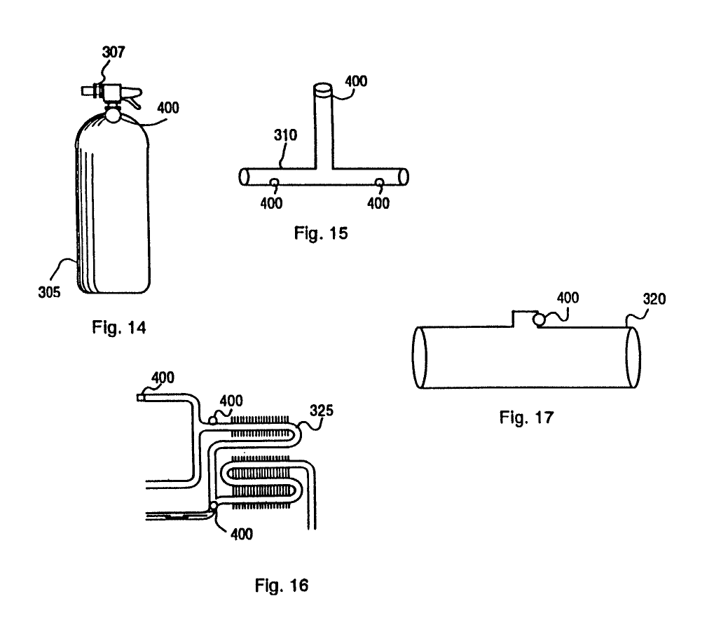

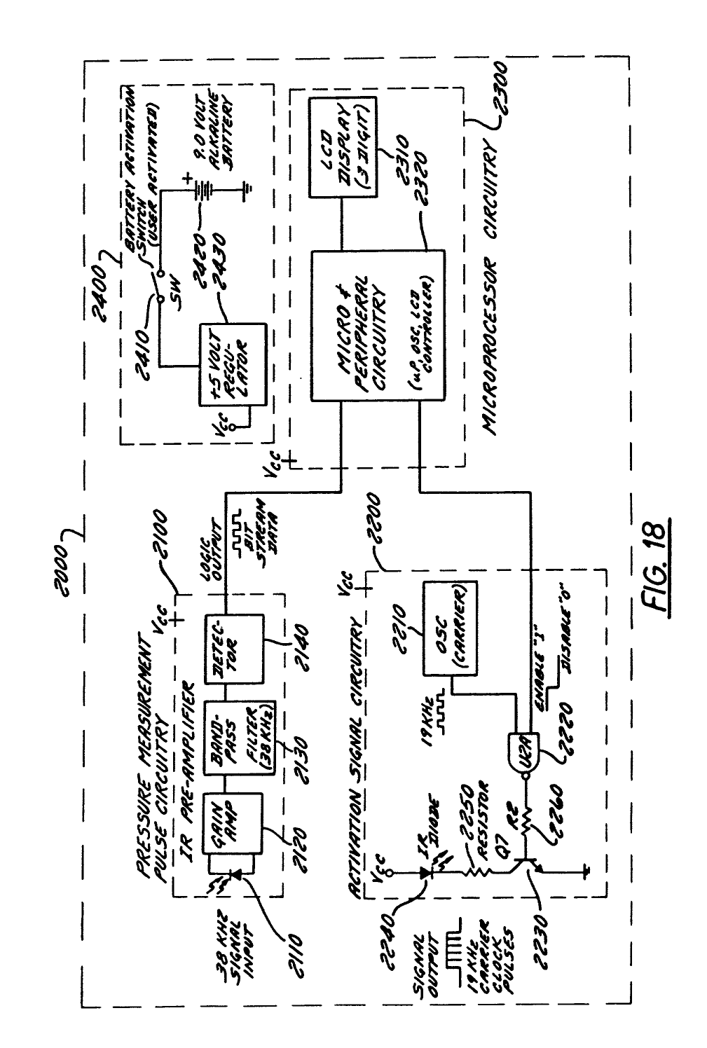

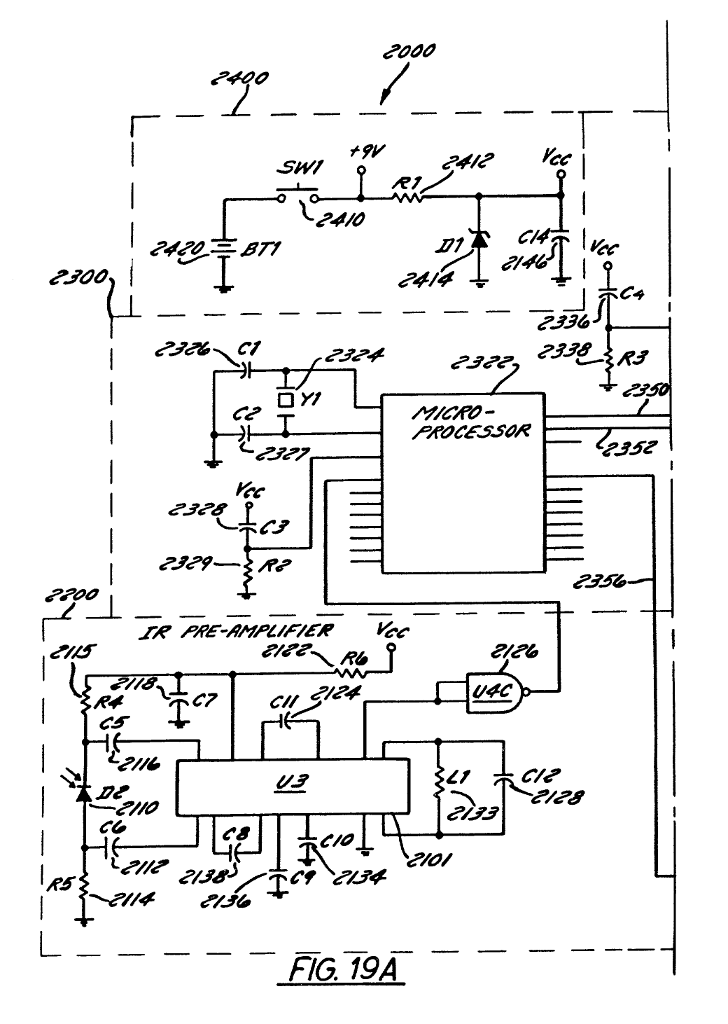

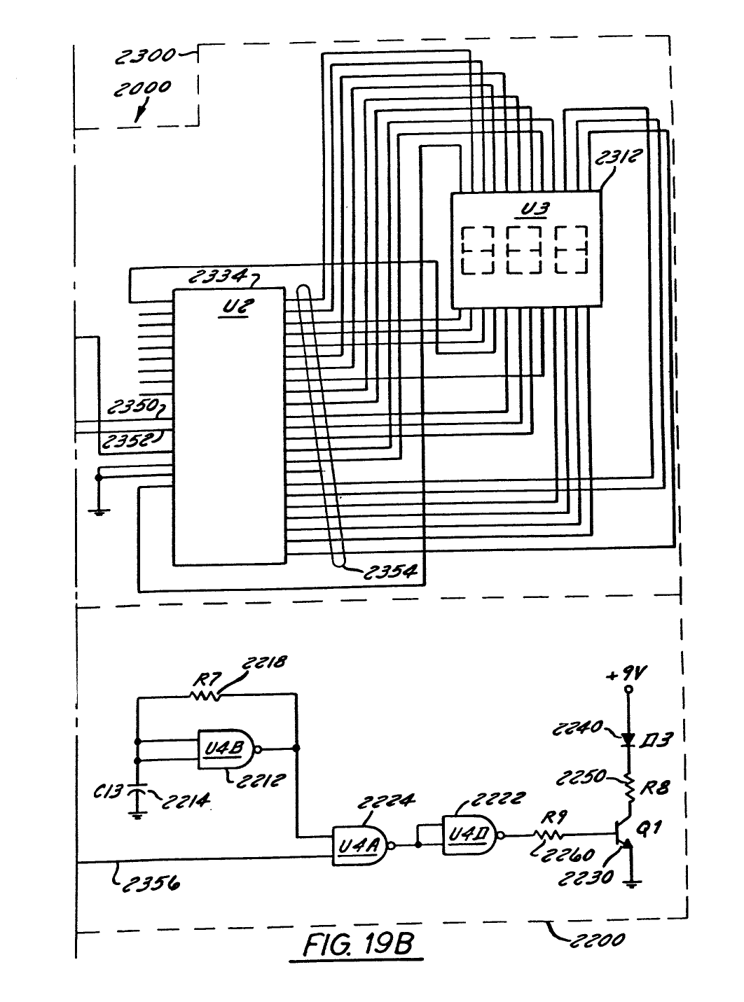

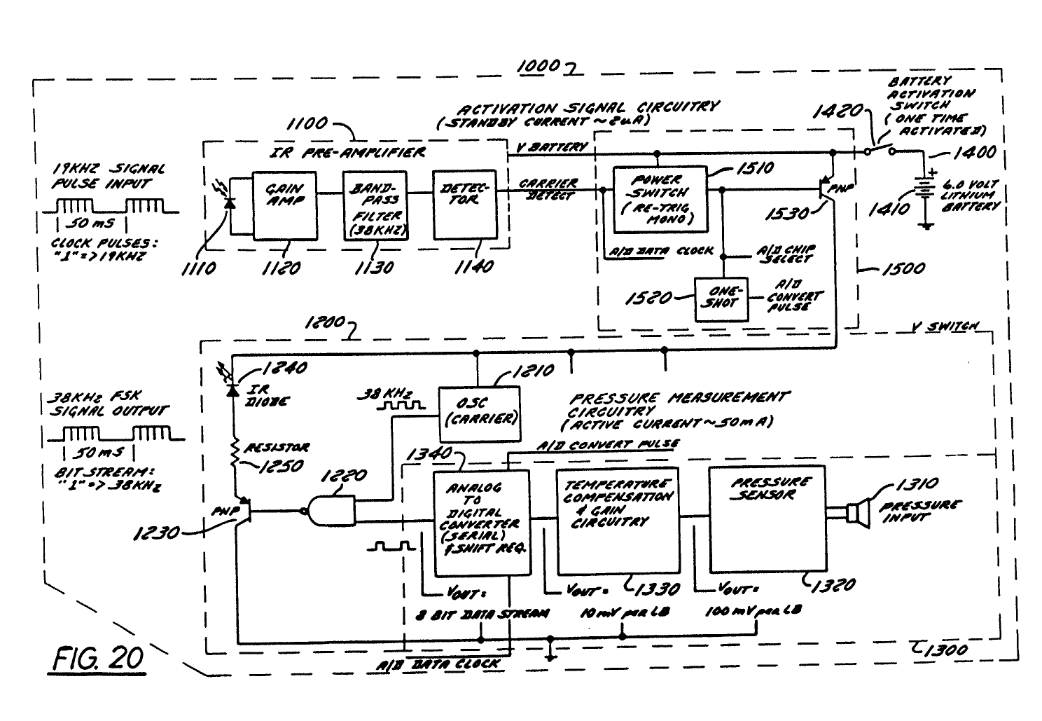

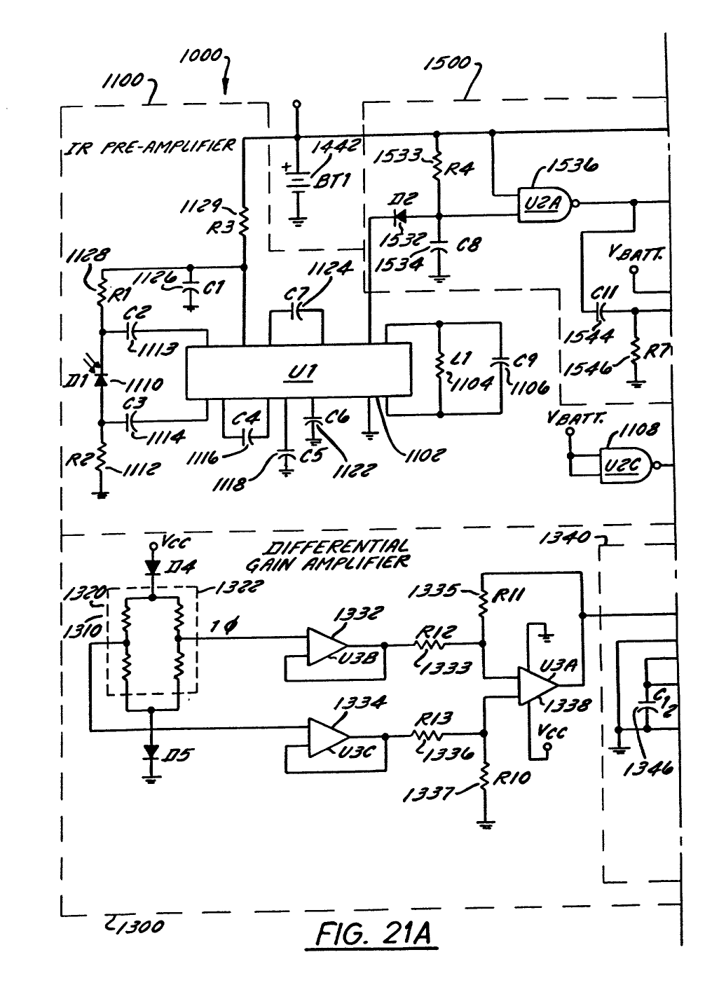

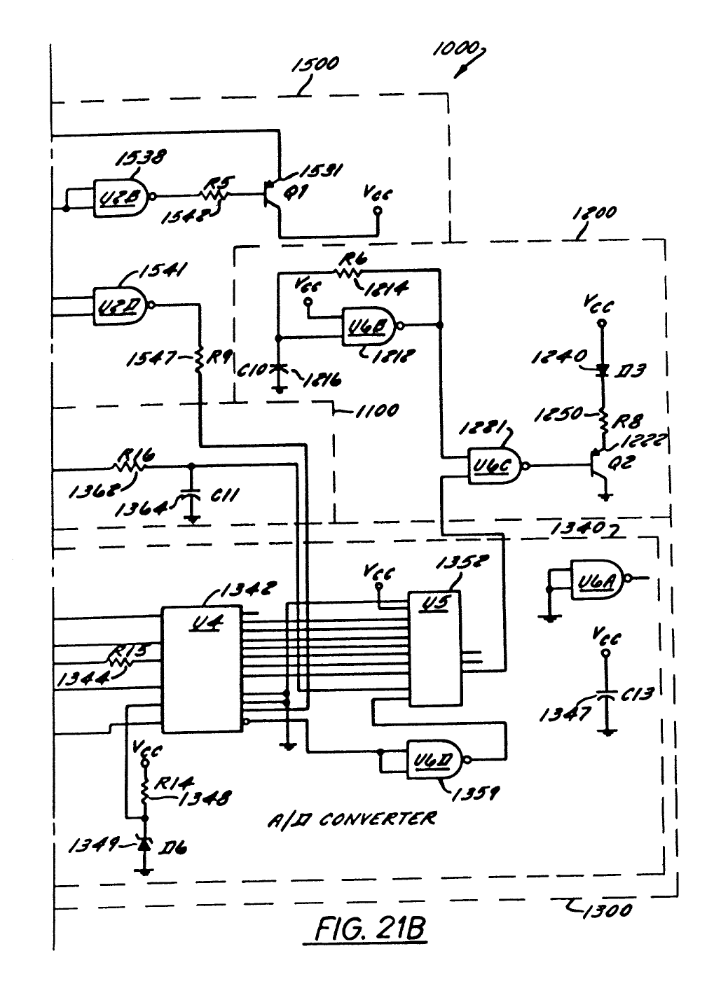

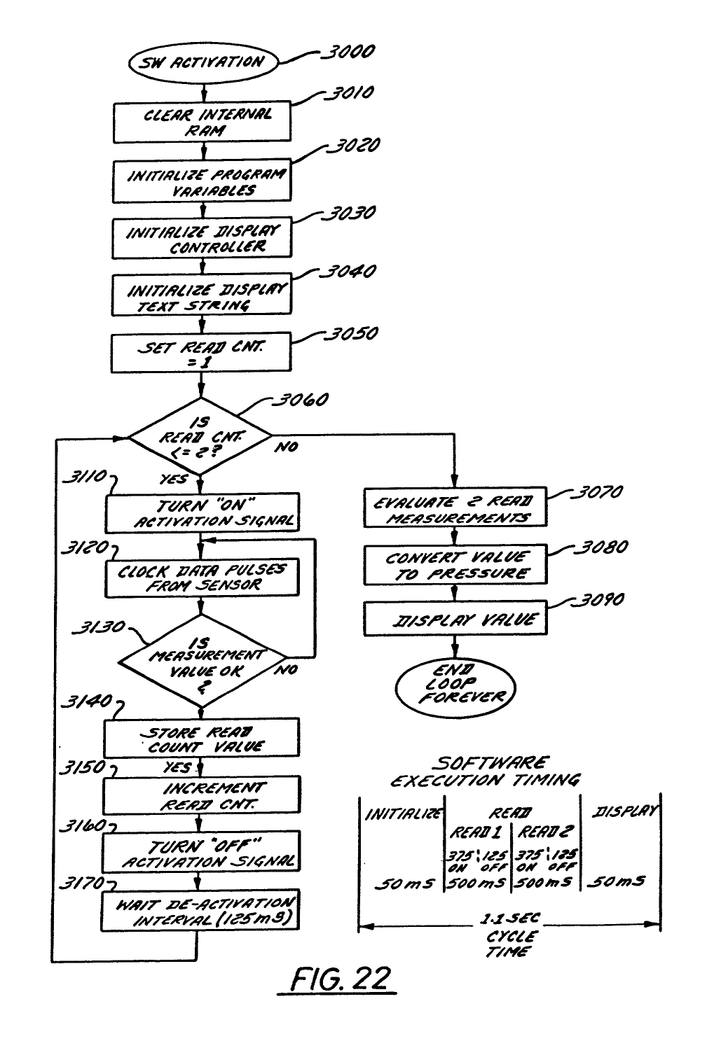

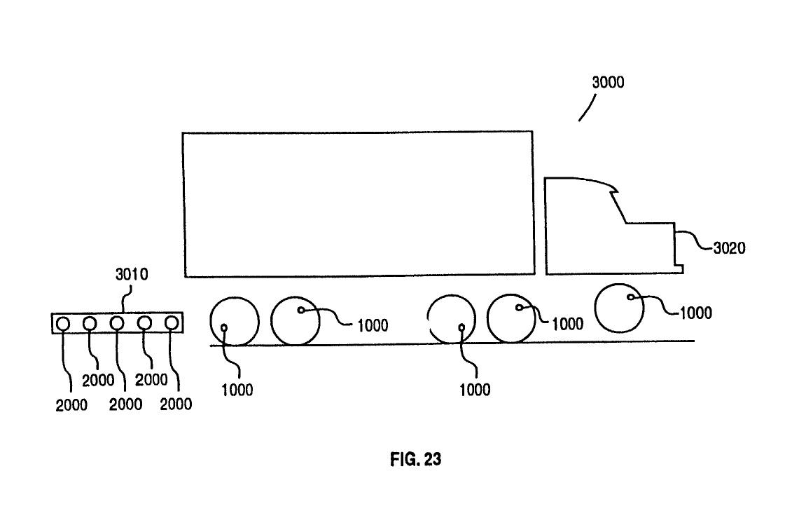

FIGS. 6A through 6E illustrate a routine 600 for creating a custom application-compatibility fix that may be dynamically applied to an application. Routine 600 begins at block 602, where the databases and database contents are displayed. The databases include the system databases for storing the compatibility fixes 208 and the compatibility modes 210 provided by the operating system 134. The custom databases 212 and custom database contents are also shown on the display. After displaying the database and database contents, routine 600 proceeds to decision block 604, where a test is made to determine whether or not the user wants to create a new custom database. In one embodiment, an option for creating a new custom database is displayed to the user. In this embodiment, a new custom database is created upon the user's selection of the new custom database option. If the user wants to create a new custom database, routine 600 proceeds to block 606, where a new custom database is created and routine 600 then proceeds to block 608. If the user does not want to create a new custom database, routine 600 proceeds to block 608. At block 608, routine 600 receives a working custom database selection, which may be either a newly created custom database or an existing custom database displayed by the compatibility administrator at block 602. After receiving the working custom database selection, routine 600 proceeds to decision block 610, where a test is made to determine whether or not the user wishes to add a custom application-compatibility fix. If it is determined that a custom application-compatibility fix is to be added, routine 600 proceeds to block 612, shown in FIG. 6B. If it is determined that no custom application-compatibility fix is to be added, routine 600 cycles back to block 602 and the foregoing steps are repeated.

FIG. 5A is a screen display 500 illustrating a representative window generated by the compatibility administrator application 206 of the present invention. The screen display 500 includes a display of the system database 504 and the custom databases 512. The system databases include applications 506, operating system-provided compatibility fixes 508, and operating system-provided compatibility modes 510. The compatibility administrator window also includes an icon 502 for enabling a new custom database creation option. A new database can also be created using a menu database option 516. The screen display 500 also displays the selected custom database by highlighting the new custom database created at block 514. The screen display also includes displaying an icon 522 for enabling a custom application-compatibility fix addition option. If the user selects the fix icon 522, the compatibility administrator application determines that a new custom application-compatibility fix is to be created.

Returning to FIG. 6B, at block 612, routine 600 receives information about the application being fixed. After receiving information about the application to be fixed, routine 600 proceeds to decision block 614, where a test is made to determine whether or not the user has requested browsing for the path to the executable file for the application to be fixed. An implementation of this feature of the invention requires that a browse option be displayed to the user, which allows the user to submit a request for browsing. If the user has requested browsing, routine 600 proceeds to block 616 where the path to the executable file for the application being fixed is browsed. In browsing for the path of the executable file for the application, routine 600 utilizes information about the application as provided by the user at block 612. After browsing for the path, routine 600 proceeds to decision block 618. If the user did not request browsing for the path at block 614, routine 600 also proceeds to decision block 618.

At decision block 618, a test is made to determine whether or not the user wishes to continue adding the custom application-compatibility fix. If the user wishes to continue adding the custom application-compatibility fix, routine 600 proceeds to block 622, shown in FIG. 6C. On the other hand, if the user does not wish to continue, routine 600 cancels the custom application-compatibility fix and routine 600 returns to block 602 shown in FIG. 6A, where the foregoing steps are repeated.

FIG. 5B is a screen display illustrating a representative window generated by the compatibility administrator application 206 of the present invention. Screen display 528 includes dialog boxes 530-534 for the user to enter information about the application to be fixed. More specifically, the user may provide the name of the program for which a custom application-compatibility fix is to be created using dialog box 530. The user may also provide the name of the vendor for the program for which a custom application-compatibility fix is being created, using dialog box 532. Additionally, the user may provide the file name of the program for which the custom application-compatibility fix is being created, using dialog box 534. Oftentimes the user may be uncertain of the program name or file name of the program for the application. In this and other situations, it may be beneficial for the user to have the ability to browse for the path to the program file for the application being fixed. Screen display 528 displays a Browse button 536, which the user may select to request browsing. Screen display 528 includes a Next button 538, the selection of which causes the compatibility administrator application to proceed with adding the custom application-compatibility fix. Screen display 528 also includes a Cancel button 540, the selection of which causes the custom application-compatibility fix to be cancelled.

Turning now to FIG. 6C at block 622, routine 600 displays the operating system-provided compatibility modes 212. After displaying the operating system-provided compatibility modes 212, routine 600 proceeds to block 624, where a compatibility mode selection is received. After receiving the compatibility mode selection, routine 600 proceeds to decision block 626, where a test is performed to determine whether the user wishes to test run the application with the selected compatibility mode. This feature of the present invention allows the user to try each compatibility mode to determine which mode solves the problem with the application being fixed. Preferably, the user request a test run by using an input device 161 to select a test run option that is displayed on video display 191 of the user's personal computer 110. If the user requests a test run, routine 600 proceeds to block 628, where the selected compatibility modes are applied to the application and the application is run in a test mode. After test running the application with the selected compatibility modes applied to the application, routine 600 proceeds to decision block 630. If, at block 626, no test run was requested, routine 600 proceeds to decision block 630.

At decision block 630, routine 600 performs a test to determine whether or not the user wants to continue adding the custom application-compatibility fix. If the user wishes to continue adding the custom application-compatibility fix, routine 600 proceeds to block 636, shown in FIG. 6D. Otherwise, if at decision block 630 it is determined that the user does not wish to continue, routine 600 proceeds to decision block 632, where a test is made to determine if the user would like to return to the application program information block 612. If the user wants to return to the application program information step, routine 600 returns to block 612, shown in FIG. 6B, and the foregoing steps are repeated. If the user does not want to return to the application program information step, routine 600 proceeds to block 634, where the process for adding the custom application-compatibility fix is canceled. After canceling the process for adding a custom application-compatibility fix, routine 600 proceeds to block 602, shown in FIG. 6A, and the foregoing steps are repeated.

FIG. 5C is a screen display illustrating a representative window generated by the compatibility administrator application 206 of the present invention. Screen display 544 includes an Operating System Modes menu 546, which lists the operating system-provided compatibility modes 210 from which the user may select the desired compatibility mode to be applied to the application being fixed. The illustrated screen display 544 lists operating system-provided compatibility modes that emulate different versions of the Microsoft operating system, namely, MICROSOFT WINDOWS 95, MICROSOFT WINDOWS NT 4.0 (SP-5), MICROSOFT WINDOWS 98/Me, and MICROSOFT WINDOWS 2000. Many application programs are developed to be run with a particular version of an operating system. The custom application-compatibility system allows a user to select an operating system compatibility mode so that the application can run with a different version of the operating system. For example, the application being fixed may be compatible only with the MICROSOFT WINDOWS 95 operating system. The user can select the MICROSOFT WINDOWS 95 compatibility mode, which will cause the current version of the operating system to emulate MICROSOFT WINDOWS 95, thereby allowing the application to work properly. Screen display 544 also includes a None button 548, which the user may select when no combination of compatibility modes will solve the application's compatibility problem. Screen display 544 further includes a Test Run button 552, which the user may select to run the application in a test mode with the selected compatibility mode(s) applied to the application. Screen display 544 also includes a Next button option 556 for continuing the process of adding the custom application-compatibility fix. In addition, screen display 544 includes a Cancel button 558 for canceling the custom application-compatibility fix. Additionally, the screen display 544 includes a Back button 554 for returning the user to step of entering application program information.

Turning now to FIG. 6D, at decision block 636, routine 600 displays the operating system-provided compatibility fixes. If the user did not find any compatibility mode or combination of compatibility modes that will solve the compatibility problem, the user may want to fine-tune the compatibility support by selecting the individual compatibility fixes to be applied to the application. After displaying the operating system compatibility fixes, routine 600 proceeds to block 638, where a compatibility fix selection is received. Preferably, the user selects the specific operating system-provided compatibility fixes to apply to the application from a list of operating system-provided compatibility fixes that is displayed to the user. After receiving the compatibility fix selection, routine 600 proceeds to decision block 640, where it is determined whether or not the user has requested test running the application. If the user requested test running the application, routine 600 proceeds to block 642, where the selected compatibility fixes are applied to the application and the application is run in a test mode. After test running the application with the selected compatibility fixes, routine 600 proceeds to decision block 644. If, at decision block 640, the user did not request a test run of the application, routine 600 proceeds to decision block 644.

At decision block 644, routine 600 determines whether the user has requested displaying the selected compatibility fixes. If the user has requested that the compatibility fix selection be displayed, routine 600 proceeds to block 646, where the selected compatibility fixes are displayed and, then, proceeds to decision block 648. If, at decision block 644, no compatibility fix selection display was requested, routine 600 proceeds to decision block 648. At decision block 648, routine 600 determines whether or not the user wants to continue adding the custom application-compatibility fix. If the user wishes to continue, routine 600 proceeds to block 654, shown in FIG. 6E. Otherwise, if the user does not wish to continue, routine 648 proceeds to decision block 650, where it is determined whether or not the user would like to return to the compatibility mode selection. If the user would like to return to the compatibility modes selection, routine 600 proceeds to block 622, shown in FIG. 6C. Otherwise, if at decision block 650 it was determined that the user did not wish to return to the compatibility mode selection, routine 600 proceeds to block 652, where the custom application-compatibility fix is cancelled. After canceling the custom application-compatibility fix, routine 600 proceeds to block 602 shown in FIG. 6A, and the foregoing steps are repeated.

FIG. 5D is a screen display illustrating a representative window generated by the compatibility administrator application 206 of the present invention. Screen display 562 includes Operating System Compatibility Fixes menu 564, which lists the operating system-provided compatibility fixes 208 from which the user may select the desired combination of compatibility fixes to be applied to the application. Screen display 562 illustrates that the user has select the operating system compatibility fix “APILogger” 566. Screen display 562 includes a Test Run button 570, which when selected causes the desired compatibility fixes to be applied to the application and the application program is run in a test mode. Screen display 562 also includes a Back button 572 whereby, upon selection, the user is returned to the compatibility mode selection screen. In addition, screen display 562 includes a Next button 574, which, upon selection, causes the compatibility administrator application to continue adding the custom application-compatibility fix. Screen display 562 further includes a Cancel button 576, which when selected causes the compatibility administrator application to cancel the custom application-compatibility fix. Screen display 562 additionally includes a Show Selected button 568, which when selected will cause the compatibility administrator application to display the selected compatibility fixes.

Turning now to FIG. 6E, at block 654, routine 600 displays the files and file attributes for the application being fixed. The user may select the desired files and the file attributes for identifying and matching the application files to be fixed. Routine 600 then proceeds to decision block 656 where a test is made to determine whether or not the user has requested the automatic identification of the application files to be fixed. If the user requested automatic application identification, routine 600 proceeds to block 658 where the files residing near the application being fixed are automatically identified. Preferably, all of the files residing in the parent directory and subdirectories for the application program are identified. After identifying the application files to be fixed, routine 600 proceeds to decision block 662. If at decision block 656, it was determined that no automatic identification was requested, routine 600 proceeds to block 660. At block 660, routine 600 receives an application file and application file attribute selection for use in identifying and matching the application to be fixed.

After receiving the user's file and file attribute selection, routine 600 proceeds to decision block 662 where a test is made to determine whether the user wishes to finish adding the custom application-compatibility fix. If the user does not wish to continue adding the custom application-compatibility fix, routine 600 proceeds to decision block 664, where a test is made to determine whether or not the user wishes to return to the compatibility fix selection. If the user wants to return to the compatibility fix selection, routine 600 returns to block 636, shown in FIG. 6D. If at decision block 664 it is determined that the user does not wish to return to the compatibility fix selection, routine 600 proceeds to block 666, where the custom application-compatibility fix is canceled. After canceling the custom application-compatibility fix, routine 600 proceeds to block 602, shown in FIG. 6A, and the foregoing steps are repeated.

If, at decision block 662, it was determined that the user does wish to finish adding the custom application-compatibility fix, routine 600 proceeds to block 668. At block 668, routine 600 saves the custom application-compatibility fix in the working custom database. After storing the custom application-compatibility fix in the working custom database, routine 600 proceeds to block 602, shown in FIG. 6A, and the foregoing steps are repeated.

FIG. 5E is a screen display 580 illustrating a representative window generated by the compatibility administrator application 206 of the present invention. Screen display 580 includes a menu 582 listing the various matching information for the user to select. The matching information includes files and file attributes and is used for identifying the application programs to be fixed. For example, screen display 580 shows that the user has selected the Main Executable file 590. Screen display 580 also shows that user has selected attributes for the Main Executable file 590. Screen display 580 also includes Add File and Rename File buttons 584 and 586, the selection of which allows files to be added and removed. In addition, screen display 580 includes an Auto Generate button 588, the selection of which causes the compatibility administrator application to automatically identify the files residing near the application being fixed. Screen display 580 also includes a Back button 590 the selection of which returns the user to the compatibility fix selection screen. Screen display 580 further includes a Finish button 592, the selection of which causes the compatibility administrator application to store the selected compatibility fixes in the working custom database. Screen display 580 also includes a Cancel button 594, which, when selected, causes the cancellation of the custom application-compatibility fix. After selecting the Finish button 592 or the Cancel button 594, the compatibility administrator application displays the screen display shown in FIG. 5A. Selection of the Finish button 592 causes the new custom application-compatibility fix to be displayed in the contents of the custom database 514 in which the custom compatibility fix was stored.

While the presently preferred embodiment and actual embodiment of the present invention has been illustrated and described above, it will be appreciated that various changes can be made therein without departing from the spirit and scope of the invention as defined by the appended claims.

The embodiments of the invention in which an exclusive property or privilege is claimed are defined as follows:

1. A computer-implemented method for dynamically applying a custom application-compatibility fix to an application, comprising:
receiving a request to launch an application;
determining if there is a custom database for said requested application, wherein said custom database contains an operating system-provided compatibility fix;
if there is a custom database for said requested application, adding said compatibility fix in said custom database to a list of compatibility fixes for said requested application;
applying said compatibility fixes on said list to said requested application; and
launching said requested application.

2. The method of claim 1, wherein said custom database is capable of storing a plurality of operating system-provided compatibility fixes and said plurality of compatibility fixes are added to said list of compatibility fixes for said requested application.

3. The method of claim 1, wherein determining if there is a custom database for said requested application further comprises:
determining if a central database contains one identifying attribute of an incompatible application that matches one identifying attribute of said requested application; and
if one identifying attribute of said incompatible application matches one identifying attribute of said requested application, determining if said central database contains information about a custom database for said incompatible application.

4. The method of claim 3, wherein said one identifying attribute is an executable name attribute.

5. The method of claim 3, wherein determining if there is a custom database for said requested application further comprises:
if one identifying attribute of said incompatible application matches one identifying attribute of said requested application, and if said central database contains information about a custom database for said incompatible application, determining if said custom database for said incompatible application contains additional identifying attributes of said incompatible application that match additional identifying attributes of said requested application.

6. The method of claim 5, wherein said additional identifying attributes include a size attribute, a version attribute, and a checksum attribute.

7. The method of claim 1, further comprising, after receiving said request to launch said first application and prior to applying said compatibility fixes on said list to said requested application, the steps of:
determining if there is an operating system-provided compatibility fix for said requested application; and
if there is an operating system-provided compatibility fix for said requested application, adding said operating system-provided compatibility fix to said list of compatibility fixes for said requested application.

8. The method of claim 7, wherein determining if there is an operating system-provided compatibility fix for said requested application further comprises:
determining if a central database contains identifying attributes of an incompatible application that match identifying attributes of said requested application; and
if said identifying attributes of said one incompatible application match identifying attributes of said requested application, determining if said central database contains information about an operating system-provided compatibility fix for said incompatible application.

9. The method of claim 1, further comprising, after receiving said request to launch said first application and prior to applying said compatibility fixes on said list to said requested application, the steps of:
determining if there is an operating system-provided compatibility mode for said requested application; and
if there is an operating system-provided compatibility mode for said requested application, adding said set of compatibility fixes in said compatibility mode to said list of compatibility fixes for said requested application.

10. The method of claim 9, wherein determining if there is an operating system-provided compatibility mode for said requested application further comprises:
determining if a central database contains identifying attributes of an incompatible application that match identifying attributes of said requested application; and
said identifying attributes of said incompatible application match identifying attributes of said requested application, determining if said central database contains information about an operating system-provided compatibility mode for said incompatible application.

11. A computer-readable medium containing computer-executable instructions for performing the method of any of claims 1-10.

12. A computer-controlled apparatus capable of performing the method of any of claims 1-10.

13. A computer-implemented method for dynamically applying a custom application-compatibility fix to an application, comprising:
receiving a request to launch an application;
determining if there is a custom database for said requested application, wherein said custom database contains an operating system-provided compatibility mode, wherein said operating system-provided compatibility mode contains a set of operating system-provided compatibility fixes;
if there is a custom database for said requested application, adding said set of operating system-provided compatibility fixes in said operating system-provided compatibility mode in said custom database to a list of compatibility fixes for said requested application;
applying said compatibility fixes on said list to said requested application; and
launching said requested application.

14. The method of claim 13, wherein said custom database contains a plurality of operating system-provided compatibility modes, wherein the sets of operating system-provided compatibility fixes in said plurality of compatibility modes are added to said list of compatibility fixes for said requested application.

15. The method of claim 13, wherein said custom database contains an operating system-provided compatibility fix and said operating system-provided compatibility mode, wherein said operating system-provided compatibility fix is added to said list of compatibility fixes for said requested application.

16. The method of claim 13, wherein determining if there is a custom database for said first application further comprises:
determining if a central database contains one identifying attribute of an incompatible application that matches one identifying attribute of said requested application; and
if one identifying attribute of said incompatible application matches one identifying attribute of said requested application, determining if said central database contains information about a custom database for said incompatible application.

17. The method of claim 16, wherein said one identifying attribute is an executable name attribute.

18. The method of claim 16, wherein determining if there is a custom database for said requested application further comprises:
if one identifying attribute of said incompatible application matches one identifying attribute of said requested application, and if said central database contains information about a custom database for said incompatible application, determining if said custom database for said incompatible application contains additional identifying attributes of said incompatible application that match additional identifying attributes of said requested application.

19. The method of claim 18, wherein said additional identifying attributes include a size attribute, a version attribute, and a checksum attribute.

20. The method of claim 13, further comprising, after receiving said request to launch said requested application and prior to applying said compatibility fixes on said list to said requested application, the steps of:
determining if there is an operating system-provided compatibility fix for said requested application; and
if there is an operating system-provided compatibility fix for said requested application, adding said operating system-provided compatibility fix to said list of compatibility fixes for said requested application.

21. The method of claim 20, wherein determining if there is an operating system-provided compatibility fix for said requested application further comprises:
determining if a central database contains identifying attributes of an incompatible application that match identifying attributes of said requested application; and
said identifying attributes of said one incompatible application match identifying attributes of said requested application, determining if said central database contains information about an operating system-provided compatibility fix for said incompatible application.

22. The method of claim 13, further comprising, after receiving said request to launch said requested application and prior to applying said compatibility fixes on said list to said requested application, the steps of:
determining if there is an operating system-provided compatibility mode for said requested application; and
if there is an operating system-provided compatibility mode for said requested application, adding said set of compatibility fixes in said compatibility mode to said list of compatibility fixes for said requested application.

23. The method of claim 22, wherein determining if there is an operating system-provided compatibility mode for said requested application further comprises:
determining if a central database contains identifying attributes of an incompatible application that match identifying attributes of said requested application; and
if said identifying attributes of said incompatible application match identifying attributes of said requested application, determining if said central database contains information about an operating system-provided compatibility mode for said incompatible application.

24. A computer-readable medium containing computer-executable instructions for performing the method of any of claims 13-23.

25. A computer-controlled apparatus capable of performing the method of any of claims 13-23.

26. A computer-implemented method for creating a custom application-compatibility fix, comprising:
identifying an application to be fixed;
selecting an operating system-provided compatibility fix; and
storing said selected operating system-provided compatibility fix in a custom database for said application.

27. The method of claim 26, further comprising selecting a plurality of operating system-provided compatibility fixes for said application and storing said plurality of selected operating system-provided compatibility fixes in said custom database for said application.

28. The method of claim 26, further comprising:
storing identifying attributes of said application in a central database; and
storing information about said custom database for said application in said central database.

29. The method of claim 26, further comprising:
storing additional identifying attributes of said application in said custom database for said application.

30. The method of claim 26, further comprising:
in response to the user selecting an option for automatically generating identifying attributes for said application, automatically generating identifying attributes for all files residing near said application.

31. The method of claim 26, further comprising:
in response to the user selecting a test run option, applying said selected operating system-provided compatibility fixes and running said application in a test mode.

32. A computer-readable medium containing computer-executable instructions for performing the method of any of claims 26-31.

33. A computer-controlled apparatus capable of performing the method of any of claims 26-31.

34. A computer-implemented method for creating a custom application-compatibility fix, comprising:
identifying an application to be fixed;
selecting an operating system-provided compatibility mode, wherein said operating system-provided compatibility mode is a set of operating system-provided compatibility fixes; and
storing said set of compatibility fixes in said selected operating system-provided compatibility mode in a custom database for said application.

35. The method of claim 34, further comprising selecting a plurality of operating system-provided compatibility modes for said application and storing the sets of compatibility fixes in said plurality of selected operating system-provided compatibility modes in said custom database for said application.

36. The method of claim 34, further comprising:
storing identifying attributes of said application in a central database; and
storing information about said custom database for said application in said central database.

37. The method of claim 34, further comprising:
storing additional identifying attributes of said application in said custom database for said application.

38. The method of claim 34, further comprising:
in response to the user selecting an option for automatically generating identifying attributes for said application, automatically generating identifying attributes for all files residing near said application.

39. The method of claim 34, further comprising:
in response to the user selecting a test run option, applying said selected operating system-provided compatibility mode to said application and running said application in a test mode.

40. A computer-readable medium containing computer-executable instructions for performing the method of any of claims 34-39.

41. A computer-controlled apparatus capable of performing the method of any of claims 34-39.

42. A computer-implemented method for creating a custom application-compatibility fix and dynamically applying the custom application-compatibility fix to an application, comprising:
identifying a first application to be fixed;
selecting an operating system-provided compatibility fix;
storing said selected compatibility fix in a custom database for said first application;
receiving a request for launching a second application;
determining if there is a custom database for said second application;
if there is a custom database for said second application, adding a compatibility fix in said custom database for said second application to a list of compatibility fixes for said second application;
applying said compatibility fixes on said list to said second application; and
launching said second application.

43. The method of claim 42, further comprising:
storing identifying attributes of said first application in a central database; and
storing information about said custom database for said first application in said central database.

44. The method of claim 43, wherein determining if there is a custom database for said second application further comprises:
determining if said central database contains one identifying attribute of an incompatible application that matches one identifying attribute of said second application; and
if one identifying attribute of said incompatible application matches one identifying attribute of said second application, determining if said central database contains information about a custom database for said incompatible application.

45. The method of claim 44, further comprising:
storing additional identifying attributes of said first application in said custom database for said first application.

46. The method of claim 45, wherein determining if there is a custom database for said second application further comprises:
if one identifying attribute of said incompatible application matches one identifying attribute of said second application, and if said central database contains information about a custom database for said incompatible application, determining if said custom database for said incompatible application contains additional identifying attributes of said incompatible application that match additional identifying attributes of said second application.

47. The method of claim 42, wherein said first application and said second application are the same.

48. A computer-readable medium containing computer-executable instructions for performing the method of any of claims 42-47.

49. A computer-controlled apparatus capable of performing the method of any of claims 42-47.

50. A computer-implemented method for creating a custom application-compatibility fix and dynamically applying the custom application-compatibility fix to an application, comprising:
identifying a first application to be fixed;
selecting an operating system-provided compatibility mode, wherein the compatibility mode contains a set of operating system-provided compatibility fixes;
storing said set of compatibility fixes contained in said selected compatibility mode in a custom database for said first application;
receiving a request for launching a second application;
determining if there is a custom database for said second application;
if there is a custom database for said second application, adding the set of compatibility fixes stored in said custom database for said second application to a list of compatibility fixes for said second application;
applying said compatibility fixes on said list to said requested application; and
launching said requested application.

51. The method of claim 50, further comprising:
storing identifying attributes of said first application in a central database; and
storing information about said custom database for said first application in said central database.

52. The method of claim 51, wherein determining if there is a custom database for said second application further comprises:
determining if said central database contains one identifying attribute of an incompatible application that matches one identifying attribute of said second application; and
one identifying attribute of said incompatible application matches one identifying attribute of said second application, determining if said central database contains information about a custom database for said incompatible application.

53. The method of claim 52, further comprising:
storing additional identifying attributes of said first application in said custom database for said first application.

54. The method of claim 53, wherein determining if there is a custom database for said second application further comprises:
if one identifying attribute of said incompatible application matches one identifying attribute of said second application, and if said central database contains information about a custom database for said incompatible application, determining if said custom database for said incompatible application contains additional identifying attributes of said incompatible application that match additional identifying attributes of said second application.

55. The method of claim 50, wherein said first application and said second application are the same.

56. A computer-readable medium containing computer-executable instructions for performing the method of any of claims 50-55.

57. A computer-controlled apparatus capable of performing the method of any of claims 50-55.

58. A computer system for dynamically applying a custom application-compatibility fix, comprising:
an operating system;
an operating system-provided compatibility fix;
a plurality of applications;
a custom database for a first one of said plurality of applications that is incompatible with said operating system, wherein said custom database contains said operating system-provided compatibility fix; and
wherein said operating system is operative to receive a request to launch a second one of said plurality of applications, to determine if there is a custom database for said second application, to add the compatibility fixes in said custom database to a list of compatibility fixes for said second application if there is a custom database for said second application, to apply said compatibility fixes on said list to said second application, and to launch said second application.

59. The computer system of claim 58, further comprising:
a central database capable of storing an identifying attribute of said incompatible application and information about said custom database for said incompatible application; and
wherein said operating system is further operative to determine if there is a custom database for said second application by determining if said identifying attribute of said incompatible application matches said identifying attribute of said second application.

60. The computer system of claim 59, wherein said custom database for said incompatible application includes additional identifying attributes of said incompatible application; and
wherein said operating system is further operative to determine if there is a custom database for said second application by determining if said additional identifying attributes of said incompatible application in said custom database match said additional identifying attributes of said second application.

61. A computer system for dynamically applying a custom application-compatibility fix, comprising:
an operating system;
a plurality of operating system-provided compatibility fixes;
an operating system compatibility mode, wherein said operating system-provided compatibility mode is a set of operating system-provided compatibility fixes;
a plurality of applications;
a custom database for a first one of said plurality of applications that is incompatible with said operating system, wherein said custom database contains said operating system-provided compatibility mode; and
wherein said operating system is operative to receive a request to launch a second one of said plurality of applications, to determine if there is a custom database for said second application, to add said set of compatibility fixes in said compatibility mode in said custom database to a list of compatibility fixes for said second application if there is a custom database for said second application, to apply said set of compatibility fixes on said list to said second application, and to launch said second application.

62. The computer system of claim 61, further comprising:
a central database capable of storing an identifying attribute of said incompatible application and information about said custom database for said incompatible application; and
wherein said operating system is further operative to determine if there is a custom database for said second application by determining if said identifying attribute of said incompatible application matches said identifying attribute of said second application.

63. The computer system of claim 61, wherein said custom database for said incompatible application includes additional identifying attributes of said incompatible application; and
wherein said operating system is further operative to determine if there is a custom database for said second application by determining if said additional identifying attributes of said incompatible application in said custom database match said additional identifying attributes of said second application.

64. A computer system for creating a custom application-compatibility fix, comprising:
an operating system;
a system database for storing a plurality of operating system-provided compatibility fixes;
a system database for storing a plurality of operating system-provided compatibility modes, wherein each operating system-provided compatibility mode is a set of operating system-provided compatibility fixes;
a plurality of applications;
a custom database for one of said plurality of applications that is incompatible with said operating system, wherein said custom database is capable of storing an operating system-provided compatibility mode and an operating system-provided compatibility fix; and
a compatibility administrator application operative to create said custom database for said incompatible application.

65. The computer system of claim 64, wherein the compatibility administrator application is further operative to provide a user interface for use in association with creating said custom database for said application, wherein the user interface is displayed to a user and comprises one or more dialog boxes for requesting information about said incompatible application from the user.

66. The computer system of claim 65, wherein said user interface further comprises:
an option to browse for the path to the executable file for said incompatible application; and
wherein, upon selection of said browse option, said compatibility administrator application is further operative to browse for the path of the executable file for said incompatible application that matches said information provided by the user about said incompatible application.

67. The computer system of claim 65, wherein said user interface further comprises:
a menu containing a list of identifying attributes of said incompatible application; and
wherein, upon selection of one of said identifying attributes, said compatibility administrator application is further operative to identify said incompatible application using said selected identifying attribute.

68. The computer system of claim 65, wherein said user interface provided by said compatibility administrator application further comprises:
an option for automatically identifying said incompatible application; and
wherein, upon selection of said automatic identification option, said compatibility administrator application is further operative to automatically generate identifying attributes of all files residing near said incompatible application.

69. The computer system of claim 65, wherein said user interface further comprises:
a menu containing a list of said operating system-provided compatibility modes; and
wherein, upon selection of one of said compatibility modes, said compatibility administrator application is further operative to store said set of compatibility fixes in said selected compatibility mode in said custom database for said incompatible application.

70. The computer system of claim 69, wherein said user interface provided by said compatibility administrator application further comprises:
a test run option; and
wherein, upon selection of said test run option, said compatibility administrator application is further operative to apply said set of compatibility fixes in said selected operating system compatibility mode to said incompatible application and run said incompatible application in a test mode.

71. The computer system of claim 65, wherein said user interface further comprises:
a menu containing a list of said operating system-provided compatibility fixes; and
wherein, upon selection of one of said compatibility fixes, said compatibility administrator application is further operative to store said selected compatibility fix in said custom database for said incompatible application.

72. The computer system of claim 71, wherein said user interface provided by said compatibility administrator application further comprises:
a test run option; and
wherein, upon selection of said test run option, said compatibility administrator application is further operative to apply said selected operating system-provided compatibility fixes to said incompatible application and run said incompatible application in a test mode.

73. A custom database providing a custom application-compatibility fix that is dynamically applied to an application by an operating system, wherein the custom database is capable of storing any combination of operating system-provided compatibility fixes and operating system-provided compatibility modes, wherein said operating system-provided compatibility mode contains a set of operating system-provided compatibility fixes.
